(19) United States
(12) Patent Application Publication
(10) Pub. No.: US 2006/0005047 A1
(43) Pub. Date: Jan. 5, 2006

(54) Memory encryption architecture

(75) Inventors: Haris Lekatsas, Princeton, NJ (US); Joerg Henkel, Exton, PA (US); Srimat Chakradhar, Manalapan, NJ (US); Venkata Jakkula, Monmouth Junction, NJ (US)

Correspondence Address: NEC LABORATORIES AMERICA, INC., 4 INDEPENDENCE WAY, PRINCETON, NJ, 08540, US

(73) Assignee: NEC Laboratories America, Inc., Princeton, NJ (US)

(21) Appl. No.: 10/869,983

(22) Filed: Jun. 16, 2004

(51) Int. Cl. G06F 11/30

(52) U.S. Cl. 713/193

(57) ABSTRACT

A system architecture is disclosed that can support fast random access to encrypted memory.

### RELATED APPLICATIONS

The present application is related to co-pending commonly-assigned United States utility patent applications “MEMORY COMPRESSION ARCHITECTURE FOR EMBEDDED SYSTEMS,” Attorney Docket No. 03041, Serial No. to be assigned, and “DYNAMIC CONTENT-AWARE MEMORY COMPRESSION AND ENCRYPTION ARCHITECTURE,” Attorney Docket No. 03041-B, Serial No. to be assigned, both filed contemporaneously with the present application and both of which are incorporated by reference herein.

### BACKGROUND OF THE INVENTION

The present invention is related to memory architectures and, more particularly, to architectures for encryption of memory.

An important issue in computer systems is the protection of sensitive (e.g. copyrighted) data during transmission or even during the runtime of an application. Encryption can solve this problem by allowing unencrypted data or code to reside only at levels of the memory hierarchy close to the processor (possibly on-chip only) where it is difficult for an adversary to gain access and reverse engineer the code or data. An important emerging area of commercial significance is streaming media that involves rapid, secure transmission of audio and video packets over a network. These packets typically employ encryption as well as compression, and clients receiving the packets are expected to decompress and decrypt the stream in real-time to provide acceptable playback. Web pages also routinely contain code (Java applets, servlets, ActiveX controls, etc.) that are transported securely over public networks. Browsers need to be able to decrypt, decompress, and execute the code snippets. Mobile environments do not yet provide widespread download and execution support for these dynamic technologies. Nevertheless, it is believed that mobile devices in the future will embed hardware that handles encryption as well as compression.

The use of encryption for protecting the contents of hard disks, for example at the hardware level or at the file system level of an operating system, is known. Research on encrypting information at the memory level, however, is rare. Since data retrieved from a cryptographic file system can appear as plaintext in an unprotected virtual memory backing store, it has been proposed to provide encryption for virtual memory. See Niels Provos. “Encrypting Virtual Memory”. 9th USENIX Security Symposium. Denver, Colo., August 2000. It has also been proposed to use encryption internal to a processor chip to protect and verify the contents of untrusted external memory. See G. Edward Suh, Dwaine Clark, Blaise Gassend, Marten van Dijk, Srinivas Devadas. “Efficient Memory Integrity Verification and Encryption for Secure Processors”. Proceedings of the 36^{th} International Symposium on Microarchitecture (MICRO-36 2003). A one-time pad technique is disclosed therein for use in encrypting data residing in the off-chip memory. The prior art, however, does not take into account the different block sizes that may result from incorporating compression in the system—or that may result from a wider range of encryption approaches. Also, embedded systems often pose additional stringent memory requirements that presents a series of challenges for incorporating memory encryption.

Accordingly, there is a need for a new hardware platform that can be readily integrated with a compression approach and achieve secure random access to encrypted information.

### SUMMARY OF INVENTION

The present invention is directed to a system architecture that can support fast random access to encrypted code or data in an incremental fashion without compromising security. In accordance with an embodiment of the invention, a buffer is deployed which holds frequently used decrypted frames that can be readily accessed by the processor. The encryption/decryption engine, which is coupled to the buffer, preferably takes advantage of a counter-mode block cipher algorithm to encrypt and decrypt pages of code or data. The architecture is advantageously independent of processor design or of the caching hierarchy utilized, if any. Unlike the prior art, this architecture can be configured to exist in any level of the memory hierarchy. Furthermore the buffer and encryption/decryption hardware can be placed inside the processor to provide one chip that performs both the tasks of a processor and an encryption/decryption unit.

The encryption/decryption engine may be readily integrated with a compression/decompression engine so as to provide a unified architecture that readily supports both encryption and compression. The present invention provides a flexible and unique design that, in particular, can work on a variety of embedded systems architectures. These and other advantages of the invention will be apparent to those of ordinary skill in the art by reference to the following detailed description and the accompanying drawings.

### BRIEF DESCRIPTION OF DRAWINGS

FIG. 1 shows the levels of memory hierarchy, in accordance with an embodiment of an aspect of the invention.

FIG. 2 illustrates random access in encryption, in accordance with an embodiment of this aspect of the invention.

FIG. 3 illustrates an example secure application execution system where software stored in insecure memory is encrypted for protection and is decrypted inside a secure integrated circuit that includes the CPU, caches, buffer and encryption/decryption devices.

FIG. 4 is an abstract diagram of the memory mapping data structure.

FIG. 5 is an abstract diagram of the free space management data structure.

### DETAILED DESCRIPTION

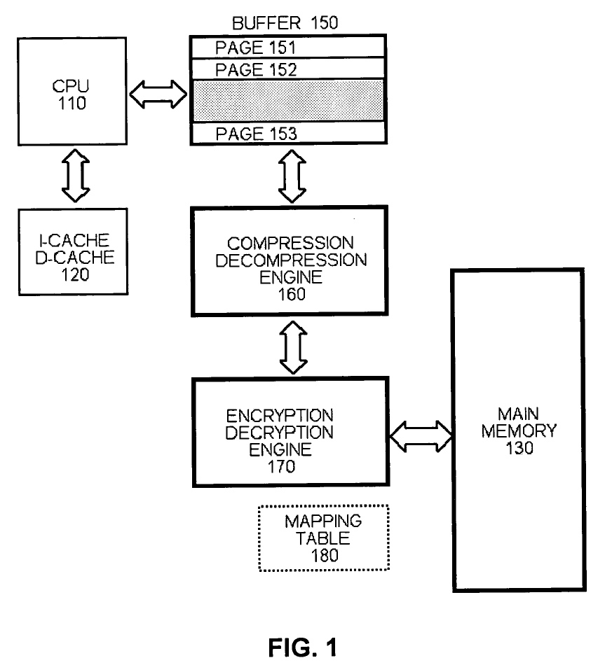

FIG. 1 is a diagram illustrating the various levels of memory hierarchy that can be used in a system built in accordance with an embodiment of an aspect of the invention. A central processing unit (CPU) 110 is shown in FIG. 1 which may or may not have one or more levels of caching 120. The cache(s) 120 can be an instruction and/or data cache. It should be noted that the memory encryption architecture disclosed herein is advantageously independent of the particular CPU and caching hierarchy utilized. This approach does not require or assume any level of caching and can be readily implemented in a system without any cache. It is assumed for illustration that the system does not provide for virtual memory.

In order to provide fast access to unencrypted data, and in accordance with an embodiment of an aspect of the invention, a buffer 150 is provided that holds one or more buffer lines 151, 152, 153, etc., of unencrypted code or data. The buffer 150 acts as an extra level of memory hierarchy that contains unencrypted data, and is placed between the cache 120 and main memory 130. It should be noted that although a single unified buffer 150 is depicted in FIG. 1 for code and data, the present invention is not so limited. As further discussed herein, alternative embodiments include having a separate buffer for code and a separate buffer for data. It should be noted that the architecture of FIG. 1 is shown only for illustration purposes and other architectures that contain encrypted data are also claimed.

The buffer lines 151, 152, 153 in the buffer 150 are in an unencrypted format and are encrypted using a encryption engine 170 before storage in main memory 130. As further described below, a block cipher algorithm; for example, can be utilized by the encryption engine 170 on each buffer line. The buffer 150 preferably maintains a mechanism for tracking the status of the buffer lines 151, 152, 153. For example, each buffer line 151, 152, 153 can contain what is referred to in the art as a “dirty” bit, which indicates whether the buffer has been modified and whether a write-back is needed. The dirty bit is set whenever there is some new data inserted in the buffer 150. The dirty data need not be encrypted and written back to memory 130 unless there is new data that needs to be refilled and the old data must be rewritten back in memory 130. When a buffer “miss” occurs, an encrypted buffer line is retrieved from memory 130, decrypted using the decryption engine 170 and placed in the buffer 150. When a new buffer line needs to be placed in the buffer 150, it may be necessary to evict an existing buffer line. It is advantageous to utilize some replacement policy to decide which buffer line to evict. For example and without limitation, a replacement policy such as “round robin” and a “least recently used” (LRU) replacement policy can be utilized.

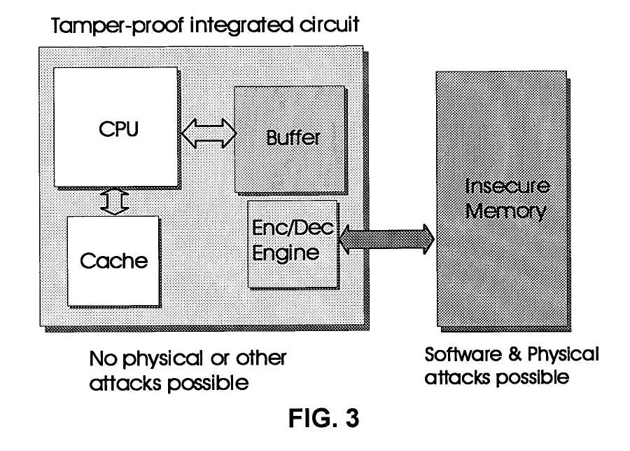

An example architecture that will benefit from our technology is illustrated in FIG. 3. The figure can be conceptually divided into two parts: tamper-proof parts that are sealed in a monolithic integrated circuit, and insecure parts that can be easily accessed. Code and data residing in insecure parts such as the memory unit depicted in FIG. 3 will always be stored in encrypted format. This ensures that intellectual property associated with such data is protected and cannot be reverse-engineered by malicious parties. Inside the tamper-proof chip, code and data is decrypted by the decryption engine and is stored in buffer and the cache, so that the processor can execute it. Any data that is transferred outside the tamper-proof chip is first encrypted.

Note that a data integrity model may also be inserted in the tamper-proof modules, to verify that the insecure memory has not been overwritten with malicious data.

An important problem with current encryption standards is the lack of random access to encrypted data. Most block cipher algorithms, which are typically used in security applications, work in some sort of block chaining mode that prevents random access. The simplest mode that a block cipher can operate in, and that does not incorporate any chaining, is the Electronic Codebook mode (ECB mode). In this mode, the data to be encrypted are separated into blocks and are encoded completely independently. While this method ensures random access at the block level, it is very insecure. Blocks that contain the same code will be encrypted with the same ciphertext, giving valuable information to a potential adversary. Other chaining modes that are considered adequately secure, e.g., where the output of block i is fed to block i+1, do not allow for random access.

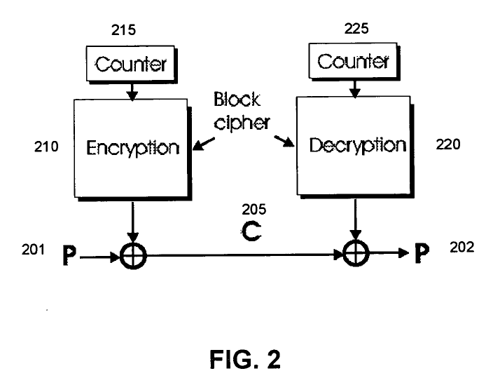

FIG. 2 illustrates a mechanism that is more secure and that does allow for random access. Plaintext P 201 is input into the encryption engine. The main idea is to encrypt a counter 215 using, for example, a block cipher 210 and combining the encrypted counter with the plaintext, for example by using an exclusive-or operation, to create the ciphertext 205. This is referred to in the art as “counter mode” encryption, and can be implemented using any of a wide-range of encryption algorithms, including the Advanced Encryption Standard (AES). See NIST, FIPS PUB 196, “Advanced Encryption Standard (AES),” November 2001; Dworkin, M., “Recommendations for Block Cipher Modes of Operation: Methods and Techniques,” NIST Special Publication 800-38A, December 2001. Since the counter value can be known by both the encryption and decryption hardware, random access is possible. The counter value for block i can be given by i+IV (mod 264) where IV is an initial counter value. Thus, this approach can allow for random access at the page level. Alternative approaches, include but are not limited to using an encrypted form of the address in memory of the block as the counter value or using other data that is part of the block itself.

The advantages of the above counter mode approach can be summarized as follows:
Unlike other modes of chaining it is fully parallelizable since counter values can be derived for any block i without encrypting any other block. Therefore very efficient hardware can be built to support this. Due to lack of dependence between encrypting block i and block i+1 it is well suited to pipelining and therefore suitable for most modern processors.
The approach enables memory encryption while allowing random access at the block level. Note that this is accomplished without compromising security.
It is evident from FIG. 2 that the encryption process can be carried away even without the knowledge of the plaintext P. A ciphertext C can be calculated later by XOR the result of the encrypted counter with P. Therefore pre-processing is possible. It is actually possible to encrypt large portions of counter values a priori to save execution time. The security of counter mode is well documented. See, e.g., Mihir Bellare, Anand Desai, Eron Jokipii, Phillip Rogaway, “A Concrete Security Treatment of Symmetric Encryption: An Analysis of the DES Modes of Operation,” Proceedings of the 38^{th} Annual Symposium on Foundations of Computer Science, 1997 (FOCS '97). Although our experiences have shown that employing counter mode in memory encryption is preferable, our invention is not limited to such encryption modes, and encompasses any system that can dynamically encrypt and decrypt memory contents for increased security on computer systems.

It should be noted that the encryption/decryption engine 170 shown in FIG. 1 need not encrypt/decrypt all code or data passing between main memory 130 and the CPU 110. It may be preferable that only the data segment or select portions of the data segment of an application be encrypted. The encryption/decryption engine 170 may be readily configured to bypass such unprotected code and data for speed of execution. Moreover, where the data or code that is being protected need not be modified, the architecture can be simplified by simply providing a decryption engine 170 and foregoing the need for a corresponding encryption engine or for the buffer 150 to keep track of modified buffer lines.

The encryption/decryption engine may be readily integrated with a compression/decompression engine so as to provide a unified architecture that readily supports both encryption and compression. As depicted in FIG. 1, the buffer 150 and the encryption/decryption engine 170 can take advantage of an additional compression/decompression engine 160 and an advantageous memory management system, such as a mapping table 180, all as further described and disclosed in United States Utility Patent Application, entitled “MEMORY COMPRESSION ARCHITECTURE FOR EMBEDDED SYSTEMS,” Serial No. TBA, filed contemporaneously with the present application and incorporated by reference herein. The architecture advantageously allows random access to the encrypted data blocks. The data space is divided into a number of frames, each frame referring to a fixed number of bytes in main memory that are encrypted individually. Typically, the frame size is equal to the buffer line, as depicted in FIG. 1, although in general it can be a multiple of the buffer line. The frames preferably have a size ranging from 1 Kbyte to 16 Kbytes. Splitting data into smaller frames than 1 KB proves to be ineffective in terms of achieving substantial compression ratios. For illustration purposes, it is assumed herein that the frame size is 1 KB. After encryption and compression, each encrypted and compressed frame will occupy less space than the original frame. In the rare event where compression cannot yield any size reduction, frames can be stored in their original form. Thus, in the general case, a 1 KB frame will encrypt and compress to any size less than or equal to 1 KB. This variable size can complicate indexing the frames significantly. It is advantageous to subdivide the frame into groups of subframes, which the inventors refer to as “CFRAMES”. CFRAMES represent the smallest addressable unit in main memory. The encrypted/compressed pages are represented as multiples of the CFRAME size. Smaller CFRAME sizes result in reduced memory fragmentation; however, smaller CFRAME sizes also result in a larger mapping table. For illustration purposes, a 1 KB frame is advantageously divided into 16 CFRAMEs, each CFRAME having a size set to 64 bytes. Moreover, a rule is imposed on block alignment of each CFRAME. For example, for the CFRAMES set to 64 bytes, all CFRAMES are aligned on a 64-byte boundary.

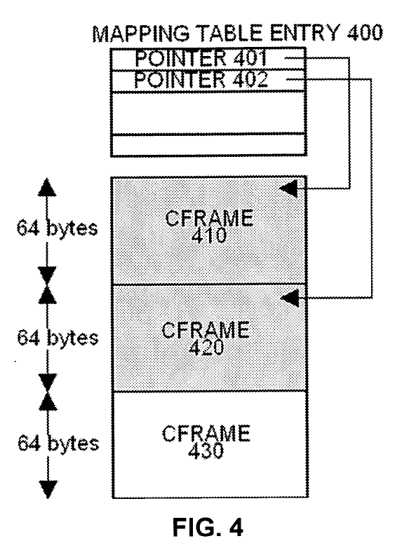

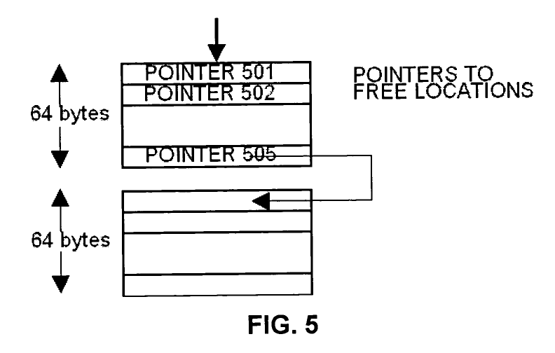

In FIG. 4, a table for mapping encrypted/compressed frames in memory is depicted. Each table entry 400 corresponds to an encrypted/compressed frame and it stores the locations of 16 CFRAMES. The memory locations can be represented as bit pointers, 401, 402, etc., each pointer pointing to a 64-bit boundary, since the CFRAMEs are aligned on 64-bit boundaries. By allocating space for 16 blocks per frame, it is ensured that any frame can be stored in the table regardless of compression ratio. An additional advantage is that the mapping table has a fixed size and, therefore, can be easily indexed, e.g., by the first bits of the frame pointer. Thus, the mapping table provides a means for finding an encrypted/compressed frame in memory. Note that the mapping table can be stored in memory along with the encrypted/compressed data. (An alternative would be to save space for frames that compress well and not allocate the space for the 16 CFRAME pointers. This, however, would complicate the design as the table would not have fixed-size entries and indexing it would be more difficult.) A structure is needed to help locate free space during writes when attempting to write a frame back to memory. FIG. 5 illustrates such a structure. The structure depicted in FIG. 5 comprises a series of pointers pointing to free space. It works as a FIFO and it can be blocked in chunks of 64 bytes. Each chunk, which consists of pointers to free locations, takes 64 bytes, and, thus, can be considered as a free 64-byte block itself

It should be noted that the above memory mapping scheme can prove advantageous in an architecture that supports encryption without compression. Although most encryption algorithms take a block of fixed size and produces an encrypted block of fixed size, in the general case, this need not be true. The above memory mapping scheme, accordingly, accommodates a wider variety of encryption approaches.

The above implementation is merely illustrative of the invention. It will be understood by those of ordinary skill in the art that various changes may be made that are within the scope of the invention, which is to be limited only by the appended claims.

What is claimed is:

1. A system comprising:
a processor;
a memory unit that holds a plurality of encrypted frames, where each encrypted frame can be randomly accessed; and
a buffer and a decryption unit interposed between the memory unit and the processor, where the decryption unit decrypts an encrypted frame stored in the memory unit into a plaintext frame and inserts the plaintext frame into a buffer line in the buffer where the plaintext frame can be accessed for processing.

2. The system of claim 1 wherein the decryption engine decrypts an encrypted frame by decrypting a counter and combining the decrypted counter with the encrypted frame to create the plaintext frame.

3. The system of claim 2 wherein the decryption engine uses a block cipher to decrypt the counter.

4. The system of claim 1 where the processor and the buffer and the decryption unit are stored inside an integrated circuit, forming an integral part that performs both application execution and decryption functions.

5. The system of claim 4 wherein the integrated circuit is tamper-resistant.

6. The system of claim 1 further comprising an encryption engine which encrypts a plaintext frame retrieved from a buffer line in the buffer into an encrypted frame and which forwards the encrypted frame to the memory unit for storage.

7. The system of claim 6 wherein the encryption engine encrypts a plaintext frame by encrypting a counter and combining the encrypted counter with the plaintext frame to create the encrypted frame.

8. The system of claim 7 wherein the encryption engine uses a block cipher to encrypt the counter.

9. The system of claim 1 wherein the buffer is a unified buffer that stores both plaintext code and data.

10. The system of claim 1 wherein the buffer further comprises a first separate buffer for code and a second separate buffer for data.

11. The system of claim 1 further comprising a mapping table which comprises entries associating a fixed size frame with locations of a plurality of subframes aligned on fixed size boundaries in the memory unit, where the fixed size frame is encrypted into a variable size encrypted frame and sub-divided into the plurality of subframes before storage in a encrypted format in the memory unit.

12. The system of claim 1 wherein the system is an embedded system.

13. A system comprising:
a processor;
a memory unit that holds a plurality of encrypted frames, where each encrypted frame can be randomly accessed; and
a buffer and a decryption unit and a decompression unit interposed between the memory unit and the processor, where the decryption unit decrypts and the decompression unit decompresses an encrypted compressed frame into a plaintext uncompressed frame and inserts the plaintext uncompressed frame into a buffer line in the buffer where the plaintext uncompressed frame can be accessed for processing.

14. The system of claim 13 wherein the decryption engine decrypts an encrypted frame by decrypting a counter and combining the decrypted counter with the encrypted frame to create the plaintext frame.

15. The system of claim 14 wherein the decryption engine uses a block cipher to decrypt the counter.

16. The system of claim 13 where the processor and the buffer and the decryption unit and the decompression unit are stored inside an integrated circuit, forming an integral part that performs both application execution and decryption and compression functions.

17. The system of claim 16 wherein the integrated circuit is tamper-resistant.

18. The system of claim 13 further comprising an encryption engine which encrypts a plaintext frame retrieved from a buffer line in the buffer into an encrypted frame.

19. The system of claim 18 further comprising a compression engine which compresses an uncompressed frame retrieved from a buffer line in the buffer into a compressed frame.

20. The system of claim 13 wherein the buffer is a unified buffer that stores both uncompressed plaintext code and data.

21. The system of claim 13 wherein the buffer further comprises a first separate buffer for code and a second separate buffer for data.

22. The system of claim 19 further comprising a mapping table which comprises entries associating a fixed size frame with locations of a plurality of subframes aligned on fixed size boundaries in the memory unit, where the fixed size frame is encrypted and compressed into a variable size encrypted compressed frame and sub-divided into the plurality of subframes before storage in a compressed format in the memory unit.

23. The system of claim 13 wherein the system is an embedded system.
